(19) United States
(12) Patent Application Publication
(10) Pub. No.: US 2016/0358580 A1
(43) Pub. Date: Dec. 8, 2016

(54) COLORING PATTERN SCREEN DISPLAY DEVICE

(71) Applicant: Azbil Corporation, Tokyo (JP)

(72) Inventor: Atsushi TAKAHASHI, Tokyo (JP)

(21) Appl. No.: 15/172,831

(22) Filed: Jun. 3, 2016

(30) Foreign Application Priority Data
Jun. 5, 2015 (JP) 2015-114647

(51) Int. Cl. G09G 5/02; G06F 3/0488; G06F 3/0484

(52) U.S. Cl. CPC G09G 5/026; G06F 3/04847; G06F 3/0488; G09G 2354/00; G09G 2320/0606; G09G 2320/066; G09G 2320/0666

(57) ABSTRACT

A plurality of coloring pattern screens in which a plurality of display objects are disposed in a background image, and which have coloring patterns where arbitrary colors are set to the background image and the plurality of display objects are stored. Frame lines are not provided in peripheries of the coloring pattern screens. A plurality of frame line added coloring pattern screens are generated, and the plurality of frame line added coloring pattern screens are displayed on a displaying portion in a case in which a mode is switched from a normal display mode in which an operation screen, where the plurality of display objects are disposed, is displayed in the displaying portion to perform a normal screen operation to a coloring pattern selection mode in which a user selects desired coloring pattern screens.

### CROSS-REFERENCE TO RELATED APPLICATION

The present application claims the benefit of and priority to Japanese Patent Application No. 2015-114647, filed on Jun. 5, 2015, the entire contents of which are incorporated by reference herein.

### TECHNICAL FIELD

The present invention relates to a coloring pattern screen display device, in particular, a coloring pattern screen display device that displays a coloring pattern screen when selecting a coloring pattern that is set in various display objects such as buttons and icons disposed in a background image H1.

### BACKGROUND ART

Conventionally, there is a touch panel device, in which a normal operation screen where a plurality of buttons that are color-coded with a plurality of colors are disposed in a background image, is displayed on a Liquid Crystal Display (LCD) and an input operation is received according to a touch (contact) to the buttons by a finger or a pen.

Since a visually impaired person with color blindness is also present among users using such a touch panel, an operation screen, in which buttons that are colored with colors which can be recognized by the visually impaired person with color blindness are disposed, is displayed on the LCD in the touch panel device (for example, see PTL 1).

In this case, the touch panel device is configured such that a plurality of screens (hereinafter, referred to as “coloring pattern screen”) to which various coloring patterns are applied to a background color of the background image and colors of the buttons are visually recognized by the visually impaired person with color blindness, and the coloring pattern screen among the plurality of coloring pattern screens, in which color of the button is recognizable by the visually impaired person with color blindness, is selected.

However, in recent years, a web design technique called “flat design” has been introduced on the display screen. The flat design is a design that is simple, easy to understand, and has no unnecessary element.

The display screen according to the flat design is configured of flat buttons and icons in which a three-dimensional representation of a frame (hereinafter, referred to as “frame line”) surrounding a periphery of the display object such as the buttons and the icons in the display screen, and the like is not present.

For example, an example of a coloring pattern screen G1, in which flat buttons and icons where the three-dimensional representation of the frame line and the like is not applied in the periphery thereof are disposed, is illustrated in FIG. 11. In the coloring pattern screen G1, a temperature displaying portion S1 and a setting temperature displaying portion S2 are disposed at the center of a background image H1 in a state of being in contact with each other in a vertical direction indicated by an arrow y.

Rectangular small buttons b1 to b6 are disposed above the temperature displaying portion S1 in a horizontal direction indicated by an arrow x in a state of being in contact with each other in a longitudinal direction. In addition, rectangular large buttons B1 to B4 are disposed below the setting temperature displaying portion S2 in the horizontal direction in an independent state without being in contact with each other. Furthermore, circular buttons C1 to C3 are disposed on the right side of the temperature displaying portion S1 and the setting temperature displaying portion S2 in the vertical direction in an independent state without being in contact with each other.

Moreover, in the following description, the temperature displaying portion S1, the setting temperature displaying portion S2, the small buttons b1 to b6, the large buttons B1 to B4, and the circular buttons C1 to C3 are referred to as “display object” in the coloring pattern screen G1.

The background image H1 of the coloring pattern screen G1 is gray, the temperature displaying portion S1 is red and the number therein is blue, the setting temperature displaying portion S2 is green and the number therein is blue, the small buttons b1, b3, and b5 are red, the small buttons b2, b4, and b6 are green, the large buttons B1 to B4 are yellow, the circular button C1 is red, the circular button C2 is green, and the circular button C3 is blue.

A person with normal color vision can distinguish all colors of the display objects set in the coloring pattern screen G1. However, for example, for the visually impaired person with color blindness who cannot distinguish between red and green which are visible as the same color, the small buttons b1 to b6 cannot be recognized as being distinguished from each other and the small buttons b1 to b6 are viewed as one button elongated in the arrow direction x in which all of the small buttons b1 to b6 are connected to each other.

### CITATION LIST

### Patent Literature

[PTL 1] JP-A-2005-78359

### SUMMARY OF THE INVENTION

### Problem that the Invention is to Solve

Meanwhile, in the coloring pattern screen G1 with such a flat design, the visually impaired person with color blindness cannot recognize the small buttons b1 to b6 as being distinguished from each other. Therefore, there is a concern that the visually impaired person with color blindness does not notice even the presence of the small buttons b1 to b6.

Therefore, if the visually impaired person with color blindness selects the coloring pattern screen G1 of the coloring pattern, there is a problem that a button operation with respect to the small buttons b1 to b6 is incorrectly performed in the normal operation screen that is actually displayed corresponding to the coloring pattern screen G1.

The invention is made to solve such a problem and an object of the invention is to provide a coloring pattern screen display device in which even a visually impaired person with color blindness is able to select a coloring pattern screen among a plurality of coloring pattern screens where presence of a display object can be correctly recognized.

### Means for Solving the Problem

In order to achieve the object, according to an aspect of the invention, there is provided a coloring pattern screen display device including: a storing portion (4) that stores a plurality of coloring pattern screens (G1 to Gn) in which a plurality of display objects (b1 to b6, S1 and S2, C1 to C3, and B1 to B4), where frame lines are not provided in peripheries thereof, are disposed in a background image (H1), and which have coloring patterns where arbitrary colors are set to the background image (H1) and the plurality of display objects (b1 to b6, S1 and S2, C1 to C3, and B1 to B4); a generating portion (5) that generates a plurality of frame line added coloring pattern screens (WG1 to WGn) where the frame lines are added to the peripheries of the plurality of display objects (13, 1 to b6, S1 and S2, C1 to C3, and B1 to B4) in the coloring pattern screens (G1 to Gn); and a display controlling portion (7) that displays the plurality of frame line added coloring pattern screens (WG1 to WGn) generated by the generating portion (5) on a displaying portion (2) in a case in which a mode is switched from a normal display mode in which an operation screen (R1), where the plurality of display objects (b1 to b6, S1 and S2, C1 to C3, and B1 to B4) are disposed, is displayed in the predetermined displaying portion (2) to perform a normal screen operation to a coloring pattern selection mode in which a user selects desired coloring pattern screens (G1 to Gn).

In addition, in the invention, the coloring pattern screen display device may further include a receiving portion (2a) that receives a selection result when the user selects the desired frame line added coloring pattern screen (WG1) from among the plurality of frame line added coloring pattern screens (WG1 to WGn). The display controlling portion (7) may generate the operation screen (R1) where the background image (H1) and the plurality of display objects (b1 to b6, S1 and S2, C1 to C3, and B1 to B4) are set in the same coloring pattern as the frame line added coloring pattern screen (WG1) corresponding to the selection result of the receiving portion and may display the operation screen (R1) on the displaying portion (2).

In the invention, a layout of the plurality of display objects (13, 1 to b6, S1 and S2, C1 to C3, and B1 to B4) disposed in the frame line added coloring pattern screen (WG1) may be the same as the plurality of display objects (13, 1 to b6, S1 and S2, C1 to C3, and B1 to B4) disposed in the operation screen (R1).

In the invention, the generating portion (5) may add the frame lines (WL and BL) of monochrome.

In the invention, the generating portion (5) may add a white frame line (WL) or a black frame line (BL) as the frame line.

In the invention, the generating portion (5) may add the white frame line (WL) or the black frame line (BL) as the frame line for each of the display objects (b1 to b6, S1 and S2, C1 to C3, and B1 to B4).

In the invention, the generating portion (5) may add a dotted frame line (DL) in which white and black are alternately arranged as the frame line.

In the invention, the generating portion (5) may include a color name adding portion (6) that adds both of a white character and a black character, which indicate names of colors that are set to the display objects (b1 to b6, S1 and S2, C1 to C3, and B1 to B4), to each of the plurality of display objects (b1 to b6, S1 and S2, C1 to C3, and B1 to B4).

In the invention, the display controlling portion (7) may alternately display the white character and the black character added to each of the plurality of display objects (b1 to b6, S1 and S2, C1 to C3, and B1 to B4) for each predetermined time.

### Advantage of the Invention

According to the invention, when the user selects the desired coloring pattern screen (G1) from among the plurality of coloring pattern screens (G1 to Gn), even if the user is a visually impaired person with color blindness, it is possible to clearly recognize the presence of the plurality of display objects (13, 1 to b6, S1 and S2, C1 to C3, and B1 to B4) by the presence of the frame lines of the frame line added coloring pattern screens (WG1 to WGn) with the plurality of frame line added coloring pattern screens (WG1 to WGn) displayed on the displaying portion (2). Therefore, it is possible to assist a visually impaired person with color blindness to select the frame line added coloring pattern screen (WG1) in which the presence of the display objects (b1 to b6, S1 and S2, C1 to C3, and B1 to B4) can be clearly recognized from among the plurality of frame line added coloring pattern screens (WG1 to WGn).

According to the invention, it is possible to display the operation screen (R1) on the displaying portion (2) by generating the operation screen (R1) where the background image (H1) and the plurality of display objects (b1 to b6, S1 and S2, C1 to C3, and B1 to B4) are set in the same coloring pattern as the frame line added coloring pattern screen (WG1) that is desired by the user and selected from among the plurality of frame line added coloring pattern screens (WG1 to WGn).

According to the invention, the layout of the plurality of display objects (13, 1 to b6, S1 and S2, C1 to C3, and B1 to B4) disposed in the frame line added coloring pattern screen (WG1) is the same as the plurality of display objects (b1 to b6, S1 and S2, C1 to C3, and B1 to B4) disposed in the operation screen (R1). Therefore, the user can visually recognize the plurality of frame line added coloring pattern screens (WG1 to WGn) having the same impression as the operation screen (R1) displayed in the normal display mode without a sense of incompatibility.

According to the invention, it is possible to clearly recognize the presence of the plurality of display objects (13, 1 to b6, S1 and S2, C1 to C3, and B1 to B4) by the frame lines (WL and BL) whose brightness is different from that of the plurality of display objects (b1 to b6, S1 and S2, C1 to C3, and B1 to B4) with the generating portion (5) adding the frame lines (WL and BL) of the monochrome.

According to the invention, in a case in which the background image (H1) and the plurality of display objects (b1 to b6, S1 and S2, C1 to C3, and B1 to B4) are dark colors whose brightness numerical value is low, it is possible to clearly recognize the presence of the plurality of display objects (b1 to b6, S1 and S2, C1 to C3, and B1 to B4) by the white frame line (WL) whose contrast ratio is high with the white frame line (WL) or the black frame line (BL) added as the frame line. In addition, in a case in which the background image (H1) and the plurality of display objects (b1 to b6, S1 and S2, C1 to C3, and B1 to B4) are bright colors whose brightness numerical value is high, it is possible to clearly recognize the presence of the plurality of display objects (b1 to b6, S1 and S2, C1 to C3, and B1 to B4) by the black frame line (BL) whose contrast ratio is high.

According to the invention, the contrast ratio of at least one of the white frame line (WL) and the black frame line (BL) becomes higher in accordance with a brightness value of a color set to the plurality of display objects (b1 to b6, S1 and S2, C1 to C3, and B1 to B4) with the white frame line (WL) or the black frame line (BL) added for each of the display objects (b1 to b6, S1 and S2, C1 to C3, and B1 to B4) as the frame lines. Therefore, it is possible to clearly recognize the presence of the display objects (13, 1 to b6, S1 and S2, C1 to C3, and B1 to B4).

According to the invention, in a case of the dark color in which the brightness value of the color of the background image (H1) and the plurality of display objects (b1 to b6, S1 and S2, C1 to C3, and B1 to B4) is low, since white configuring the white and black dotted line is mainly recognized, the white and black dotted frame line (DL) is clearly viewed by the user as a white dotted line with the white and black dotted frame line (DL) added in which white and black are alternately disposed as the frame line. In addition, in a case of the bright color in which the brightness value of the color of the background image (H1) and the plurality of display objects (b1 to b6, S1 and S2, C1 to C3, and B1 to B4) is high, since black configuring the white and black dotted line is mainly recognized, the white and black dotted frame line (DL) is clearly viewed by an operator as a black dotted line. Therefore, in the frame line added coloring pattern screen (DG1), it is possible to instantly recognize the presence of the plurality of display objects (b1 to b6, S1 and S2, C1 to C3, and B1 to B4) for the operator.

According to the invention, both of the white character and the black character, which indicate names of colors that are set to the display objects (b1 to b6, S1 and S2, C1 to C3, and B1 to B4), are added to each of the plurality of display objects (13, 1 to b6, S1 and S2, C1 to C3, and B1 to B4). Therefore, in a case of the dark color in which the brightness value of the color of the plurality of display objects (b1 to b6, S1 and S2, C1 to C3, and B1 to B4) is low, the name of the color to which the white character is added is clearly viewed by the user. Also, in a case of the bright color in which the brightness value of the color of the plurality of display objects (b1 to b6, S1 and S2, C1 to C3, and B1 to B4) is high, the name of the color to which the black character is added is clearly viewed by the user. Therefore, the user can instantly recognize the presence of the plurality of display objects (b1 to b6, S1 and S2, C1 to C3, and B1 to B4) by the frame lines and can recognize the coloring.

According to the invention, the name of the color indicated by the white character and the name of the color indicated by the black character are alternately displayed with respect to each of the plurality of display objects (b1 to b6, S1 and S2, C1 to C3, and B1 to B4) for each predetermined time. Therefore, one of the white character and the black character is clearly viewed by the user while pulling the attention of the user in a switching display of the white character and the black character. Thus, the user can also easily recognize the coloring of the plurality of display objects (b1 to b6, S1 and S2, C1 to C3, and B1 to B4).

### BRIEF DESCRIPTION OF THE DRAWINGS

FIG. 1 is an external view illustrating a configuration of a controller according to an embodiment of the invention.

FIG. 2 is a block diagram illustrating the configuration of the controller.

FIG. 3 is a block diagram illustrating a configuration of a frame line added coloring pattern screen generating portion.

FIG. 4 is a view illustrating an example of a white frame line added coloring pattern screen.

FIG. 5 is a view illustrating an example of a black frame line added coloring pattern screen.

FIG. 6 is a view illustrating a first example of a two-type frame line added coloring pattern screen.

FIG. 7 is a view illustrating a second example of the two-type frame line added coloring pattern screen.

FIG. 8 is a view illustrating an example of a white and black dotted frame line added coloring pattern screen.

FIG. 9 is a view illustrating an example of a white frame line added coloring pattern screen with a color name.

FIG. 10 is a view illustrating an example of a white and black dotted frame line added coloring pattern screen with a color name.

FIG. 11 is a view illustrating a coloring pattern screen.

### MODE FOR CARRYING OUT THE INVENTION

Hereinafter, embodiments of the invention will be described with reference to the drawings.

### <Configuration of Controller>

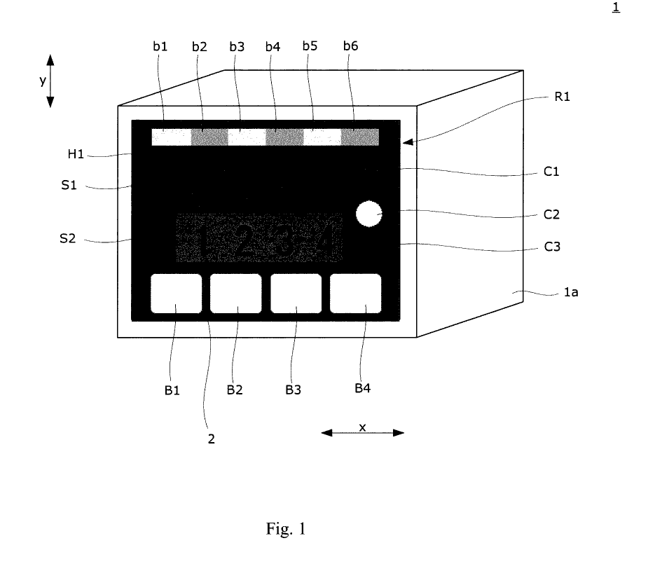

As illustrated in FIG. 1, a digital indication controller 1 (hereinafter, simply referred to as “controller”) includes a rectangular parallelepiped housing 1a, a displaying portion 2 that is configured of a touch panel type liquid crystal display provided on a front surface of the housing 1a, and a processing portion that is housed in an inside of the housing 1a and performs various processes. Moreover, the controller 1 is a temperature controller mounted on a front surface of a device (not illustrated).

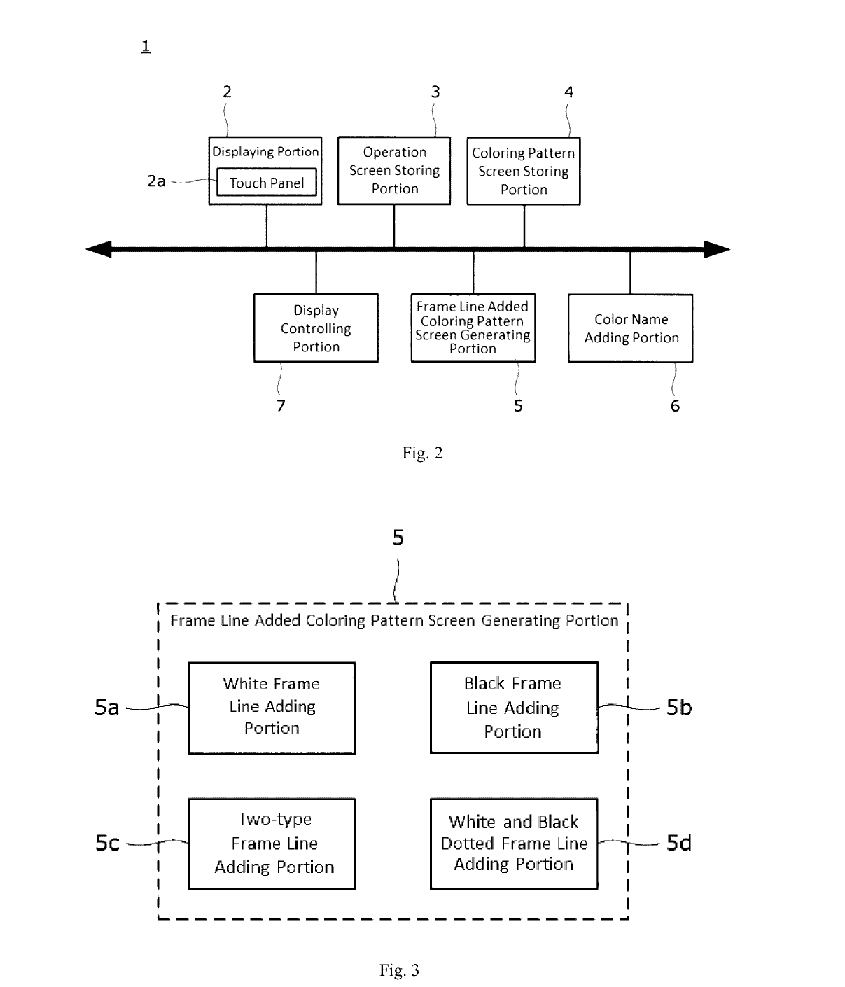

As illustrated in FIG. 2, the controller 1 includes the displaying portion 2, an operation screen storing portion 3, a coloring pattern screen storing portion 4, a frame line added coloring pattern screen generating portion 5, a color name adding portion 6, and a display controlling portion 7. Moreover, the generating portion of the invention is configured of the frame line added coloring pattern screen generating portion 5 and the color name adding portion 6.

The displaying portion 2 is a function portion that is configured of a liquid crystal display and performs various displays. In addition, the displaying portion 2 includes a resistance film type or electrostatic capacitance type touch panel 2a on a surface thereof and also functions as a receiving portion that receives instructions from an operator via the touch panel 2a.

The operation screen storing portion 3 is configured of, for example, a hard disk, a semiconductor memory, and the like. The operation screen storing portion 3 stores an operation screen R1 displayed in the displaying portion 2 in a case in which a display mode (hereinafter, referred to as “normal display mode”), where the operator normally performs a basic operation except a coloring pattern selection mode described below, is set in the controller 1.

That is, the operation screen R1 is displayed on the displaying portion 2 in a case in which the normal display mode is selected and is a screen that is used when the operator normally performs the basic operation in the normal display mode in the controller 1.

As illustrated in FIG. 1, in the operation screen R1, a temperature displaying portion S1 and a setting temperature displaying portion S2 are disposed at a center of a background image H1 in a state of being in contact with each other in a vertical direction indicated by an arrow y.

Rectangular small buttons b1 to b6 are disposed above the temperature displaying portion S1 in a horizontal direction indicated by an arrow x in a state of being in contact with each other in a longitudinal direction. In addition, rectangular large buttons B1 to B4 are disposed below the setting temperature displaying portion S2 in the horizontal direction in an independent state without being in contact with each other. Furthermore, circular buttons C1 to C3 are disposed on the right side of the temperature displaying portion S1 and the setting temperature displaying portion S2 in the vertical direction in an independent state without being in contact with each other.

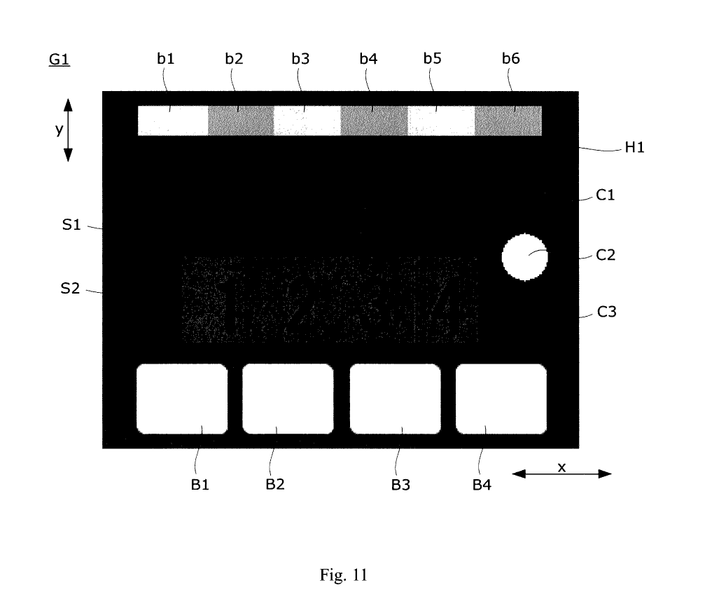

The large buttons B1 and B4 are buttons that are used for transition from the normal operation screen R1 to a coloring pattern screen G1 (see FIG. 11). If both of the large buttons B1 and B4 are continuously pressed for equal to or greater than 5 seconds, the screen is switched from the operation screen R1 to the coloring pattern screen G1 and then the large buttons B1 to B4 function as buttons for selecting the coloring pattern. In addition, in order to return from the coloring pattern screen G1 to the normal operation screen R1, both of the large buttons B1 and B4 may be continuously pressed again for equal to or greater than 5 seconds in the coloring pattern screen G1.

Furthermore, the large button B1 is a button that is used for switching types of frame lines in a frame line added coloring pattern screen described below. The large button B2 is a button that is used for switching presence or absence of a character display of a color with respect to a display object of the frame line added coloring pattern screen.

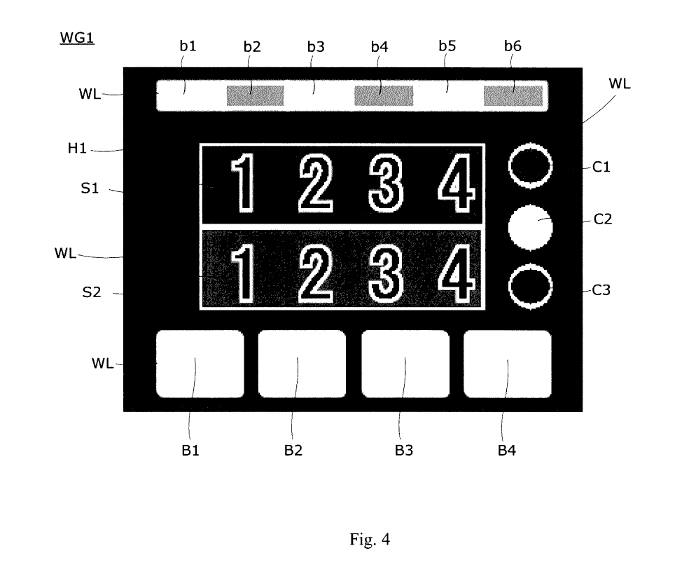

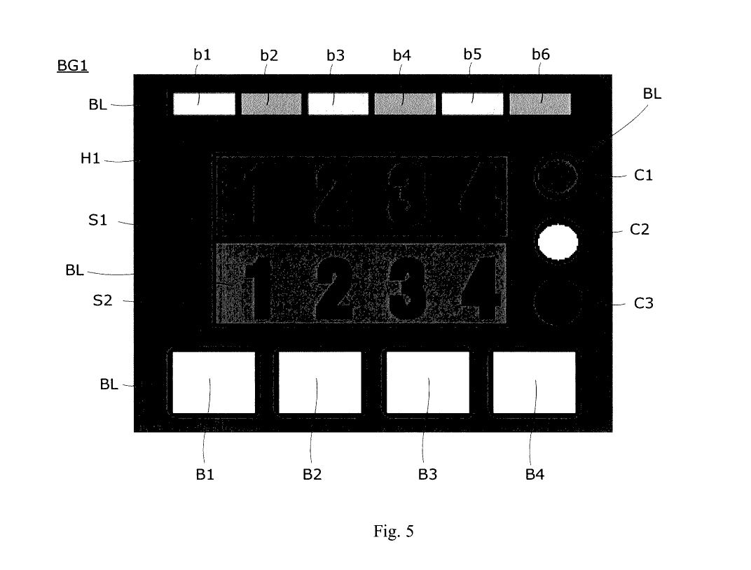

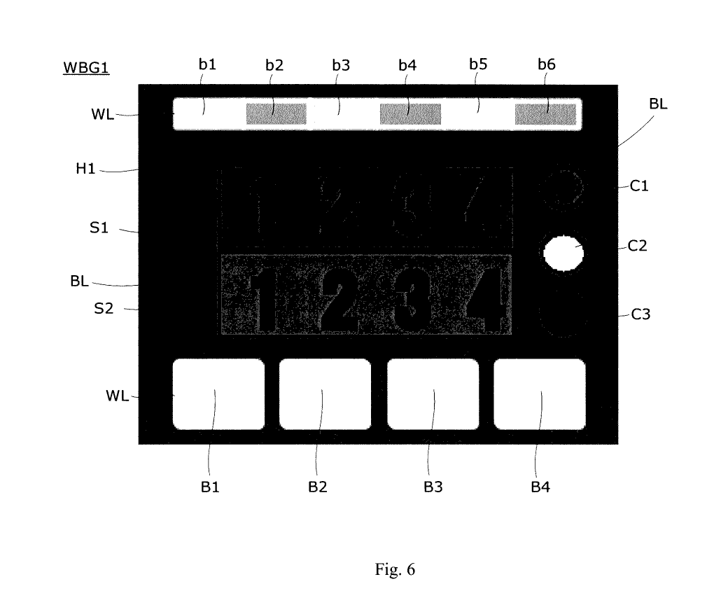

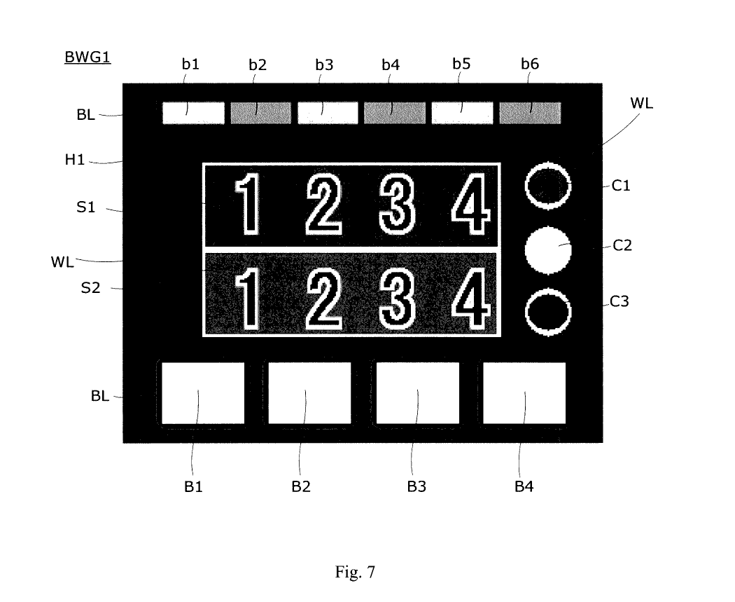

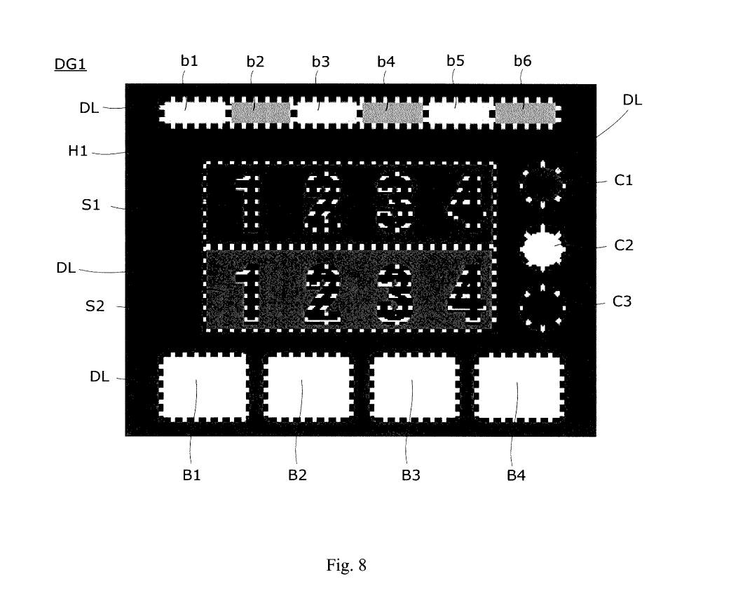

For example, whenever the large button B1 is pressed, a display of the displaying portion 2 is switched in order of a coloring pattern screen having no frame line (hereinafter, referred to as “no frame line coloring pattern screen”) G1 as illustrated in FIG. 11, a coloring pattern screen to which a white frame line is added (hereinafter, referred to as “white frame line added coloring pattern screen”) WG1 as illustrated in FIG. 4, a coloring pattern screen to which a black frame line is added (hereinafter, referred to as “black frame line added coloring pattern screen”) BG1 as illustrated in FIG. 5, a coloring pattern screen to which a two-type frame line (described below) is added (hereinafter, referred to as “two-type frame line added coloring pattern screen”) WBG1 as illustrated in FIG. 6, or a two-type frame line added coloring pattern screen BWG1 as illustrated in FIG. 7, and a coloring pattern screen to which a white and black dotted frame line (described below) is added (hereinafter, referred to as “white and black dotted frame line added coloring pattern screen”) DG1 as illustrated in FIG. 8. Furthermore, if the large button B1 is continuously pressed, it is returned to the no frame line coloring pattern screen G1.

Whenever the large button B2 is pressed, it is switched to presence of the character display of coloring with respect to the display object of the frame line added coloring pattern screen described above or to absence thereof. When it is switched to the presence of the character display, numeral displays of the temperature displaying portion S1 and the setting temperature displaying portion S2 are switched to square displays.

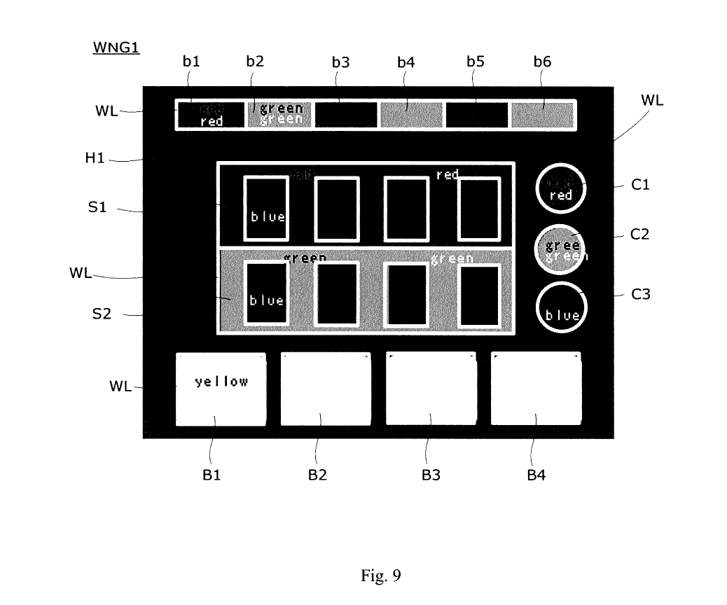

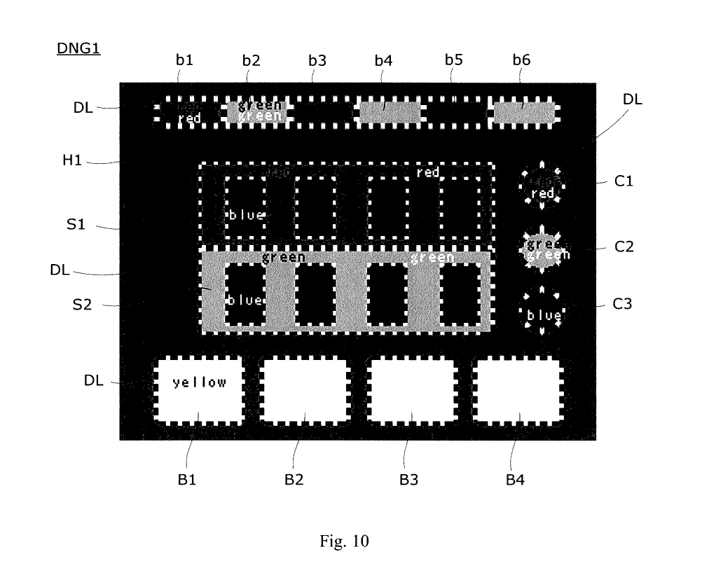

Specifically, whenever the large button B2 is pressed, it is alternately switched between the white frame line added coloring pattern screen WG1 and the white and black dotted frame line added coloring pattern screen DG1 illustrated in FIGS. 4 and 8, and a white frame line added coloring pattern screen with the color name WNG1 and a white and black dotted frame line added coloring pattern screen with the color name DNG1 illustrated in FIGS. 9 and 10.

Furthermore, the large buttons B3 and B4 are buttons that are used for switching the coloring pattern in order of the no frame line coloring pattern screen G1, the white frame line added coloring pattern screen WG1, the black frame line added coloring pattern screen BG1, the two-type frame line added coloring pattern screen WBG1 or BWG1, and the white and black dotted frame line added coloring pattern screen DG1.

Therefore, for example, in the white frame line added coloring pattern screen WG1, whenever the large button B3 is pressed, the coloring patterns of the white frame line added coloring pattern screens WG1 to WGn are switched in a forward direction, the following of the final white frame line added coloring pattern screen WGn is returned to the initial white frame line added coloring pattern screen WG1, and this is repeated.

On the other hand, in the white frame line added coloring pattern screen WG1, whenever the large button B4 is pressed, the coloring patterns of the white frame line added coloring pattern screens WG1 to WGn are switched in a reverse direction, the following of the initial white frame line added coloring pattern screen WG1 is returned to the final white frame line added coloring pattern screen WGn, and this is repeated.

Moreover, in the following description, in the operation screen R1, the temperature displaying portion S1, the setting temperature displaying portion S2, the small buttons b1 to b6, the large buttons B1 to B4, and the circular buttons C1 to C3 are referred to as “display objects”.

The background image H1 of the operation screen R1 is gray, the temperature displaying portion S1 is red and the number therein is blue, the setting temperature displaying portion S2 is green and the number therein is blue, the small buttons b1, b3, and b5 are red, the small buttons b2, b4, and b6 are green, the large buttons B1 to B4 are yellow, the circular button C1 is red, the circular button C2 is green, and the circular button C3 is blue. The background image H1 and the display objects of the operation screen R1 are set by the coloring patterns of default and it does not necessarily take into account whether or not a visually impaired person with color blindness can distinguish colors.

In addition, button names and the like indicating functions respectively assigned to buttons are displayed in inner regions of the small buttons b1 to b6, the large buttons B1 to B4, and the circular buttons C1 to C3 of the operation screen R1.

The coloring pattern screen storing portion 4 is configured of a hard disk, a semiconductor memory, and the like, and is a function portion that stores a plurality of coloring pattern screens G1 to Gn (n: integer equal to or greater than 2).

Here, the coloring pattern screens G1 to Gn are a plurality of screens prepared for being used in a mode (hereinafter, referred to as “coloring pattern selection mode”) for selecting the coloring pattern with respect to the background image H1 and the plurality of display objects of the operation screen R1 by an operator.

The coloring pattern screens G1 to Gn have the same background image H1 and plurality of display objects (the temperature displaying portion S1, the setting temperature displaying portion S2, the small buttons b1 to b6, the large buttons B1 to B4, and the circular buttons C1 to C3) as the background image H1 and the plurality of display objects of the operation screen R1.

The plurality of display objects in the coloring pattern screens G1 to Gn are provided at least in the same shape, the same size, the same number, and the same position (layout) on the background image H1 as the plurality of display objects in the operation screen R1. However, a color of the background image H1 and colors of the display objects in the coloring pattern screens G1 to Gn are set to various coloring patterns different from the coloring patterns of the operation screen R1.

Moreover, a deference between the operation screen R1 and the coloring pattern screens G1 to Gn is that button names and the like are displayed in the inner regions of the small buttons b1 to b6, the large buttons B1 to B4, and the circular buttons C1 to C3 of the operation screen R1, but those are not displayed in the coloring pattern screens G1 to Gn. The reason is that the coloring pattern screen G1 is a screen for selecting the coloring pattern with respect to the plurality of display objects and the displays of the button name and the like are not particularly needed.

A name of a color, brightness (for example, 1 (black) to 10 (white)) of a color, and the like that are set to each of the display objects of the coloring pattern screens G1 to Gn are also stored in the coloring pattern screen storing portion 4 as color information of the display objects along with the coloring pattern screens G1 to Gn.

The frame line added coloring pattern screen generating portion 5 is a function portion that generates the frame line added coloring pattern screen where the frame lines are added to peripheries of the plurality of display objects in the coloring pattern screens G1 to Gn. Here, the frame line added coloring pattern screen is a screen where the frame lines are added to the background image H1 and the plurality of display objects of the coloring pattern screens G1 to Gn. A difference between the two is presence or absence of the frame line.

The frame line added coloring pattern screen generating portion 5 includes a white frame line adding portion 5a, a black frame line adding portion 5b, a two-type frame line adding portion 5c, and a white and black dotted frame line adding portion 5d.

The white frame line adding portion 5a is a function portion that adds frame lines of white (hereinafter, referred to as “white frame line”) to peripheries of the temperature displaying portion S1, the setting temperature displaying portion S2, the small buttons b1 to b6, the large buttons B1 to B4, and the circular buttons C1 to C3 of the coloring pattern screens G1 to Gn.

The white frame line adding portion 5a generates white frame line added coloring pattern screens WG1 to WGn (see FIG. 4) where the white frame lines WL are added to all peripheries of the plurality of display objects in the coloring pattern screens G1 to Gn if a generation command of the white frame line added coloring pattern screen is recognized in accordance with a touch input by the large button B1 via the touch panel 2a of the displaying portion 2. Moreover, in FIG. 4, for the sake of convenience, only the white frame line added coloring pattern screen WG1 is displayed.

The black frame line adding portion 5b is a function portion that adds frame lines of black (hereinafter, referred to as “black frame line”) to peripheries of the temperature displaying portion S1, the setting temperature displaying portion S2, the small buttons b1 to b6, the large buttons B1 to B4, and the circular buttons C1 to C3 of the coloring pattern screens G1 to Gn.

The black frame line adding portion 5b generates black frame line added coloring pattern screens BG1 to BGn (see FIG. 5) where the black frame lines BL are added to all peripheries of the plurality of display objects in the coloring pattern screens G1 to Gn if a generation command of the black frame line added coloring pattern screen is recognized in accordance with a touch input by the large button B1 via the touch panel 2a of the displaying portion 2. Moreover, in FIG. 5, for the sake of convenience, only the black frame line added coloring pattern screen BG1 is displayed.

The two-type frame line adding portion 5c is a function portion that adds any one frame line of the white frame line WL and the black frame line BL to the periphery of each of the temperature displaying portion S1, the setting temperature displaying portion S2, the small buttons b1 to b6, the large buttons B1 to B4, and the circular buttons C1 to C3 of the coloring pattern screens G1 to Gn.

The two-type frame line adding portion 5c generates the two-type frame line added coloring pattern screens WBG1 to WBGn, BWG1 to BWGn (see FIGS. 6 and 7) where the white frame lines WL or the black frame lines BL are added to the peripheries of each of the plurality of display objects in the coloring pattern screens G1 to Gn if a generation command of the two-type frame line added coloring pattern screen is recognized in accordance with the touch input by the large button B1 via the touch panel 2a of the displaying portion 2. Moreover, in FIGS. 6 and 7, for the sake of convenience, only the two-type frame line added coloring pattern screens WBG1 and BWG1 are displayed.

For example, in the two-type frame line added coloring pattern screen WBG1, the white frame lines WL are added to the small buttons b1 to b6, the black frame lines BL are added to the peripheries of the temperature displaying portion S1 and the setting temperature displaying portion S2, the white frame lines WL are added to the peripheries of the large buttons B1 to B4, and the black frame lines BL are added to the peripheries of the circular buttons C1 to C3. In this case, whether the white frame line WL or the black frame line BL is added to which display object is determined in advance in accordance with the brightness value of the display object.

In the two-type frame line added coloring pattern screen BWG1, the white frame lines WL and the black frame lines BL added to the plurality of display objects are in a state reverse to the white frame lines WL and the black frame lines BL added to the plurality of display objects in the two-type frame line added coloring pattern screen WBG1. Also in the two-type frame line added coloring pattern screen BWG1, whether the white frame line WL or the black frame line BL is added to which display object is determined in advance in accordance with the brightness value of the display object.

The white and black dotted frame line adding portion 5d is a function portion that adds a frame line of a white and black dotted line shape (hereinafter, referred to as “white and black dotted frame line”) where white and black are alternately disposed at regular intervals in the peripheries of the temperature displaying portion S1, the setting temperature displaying portion S2, the small buttons b1 to b6, the large buttons B1 to B4, and the circular buttons C1 to C3 of the coloring pattern screens G1 to Gn.

The white and black dotted frame line adding portion 5d generates the white and black dotted frame line added coloring pattern screens DG1 to DGn (see FIG. 8) where white and black dotted frame lines DL are added to all peripheries of the display objects in the coloring pattern screens G1 to Gn if a generation command of the white and black dotted frame line added coloring pattern screen is recognized in accordance with the touch input by the large button B1 via the touch panel 2a of the displaying portion 2. Moreover, in FIG. 8, for the sake of convenience, only the white and black dotted frame line added coloring pattern screen DG1 is displayed.

The color name adding portion 6 is a function portion that adds both of an English notation of the white character and an English notation of the black character indicating a name of the color of the display object to the inner regions of the temperature displaying portion S1, the setting temperature displaying portion S2, the small buttons b1 to b6, the large buttons B1 to B4, and the circular buttons C1 to C3 in the frame line added coloring pattern screens WG1, BG1, WBG1, BWG1, and DG1.

The color name adding portion 6 generates the white frame line added coloring pattern screen with the color name WNG1 illustrated in FIG. 9, the white and black dotted frame line added coloring pattern screen with the color name DNG1 illustrated in FIG. 10, and the like where the names of the colors of the display objects are respectively added to, for example, the display objects of the white frame line added coloring pattern screen WG1 (see FIG. 4) and the white and black dotted frame line added coloring pattern screen DG1 (see FIG. 8) if a command to add the color name is recognized in accordance with the touch input by the large button B2.

Moreover, the color name adding portion 6 may also generate a black frame line coloring pattern screen with the color name or a two-type frame line coloring pattern screen with the color name (not illustrated) to which the color names of the display objects are added.

The color name adding portion 6 adds the names of the colors of the large buttons B1 to B4 with an English notation “yellow” of the white character and an English notation “yellow” of the black character to a substantially center of the large buttons B1 to B4 in the white frame line added coloring pattern screen with the color name WNG1 and the white and black dotted frame line added coloring pattern screen with the color name DNG1. However, in FIGS. 9 and 10, the English notation “yellow” of the white character and the English notation “yellow” of the black character are added to only the large button B1, and the English notation of the color name is omitted in the large buttons B2 to B4.

The display controlling portion 7 is a function portion that receives an instruction of the operator in accordance with the touch input with respect to the touch panel 2a of the displaying portion 2 and controls display contents of the displaying portion 2 by controlling the operation screen storing portion 3, the coloring pattern screen storing portion 4, the frame line added coloring pattern screen generating portion 5, and the color name adding portion 6 based on the instruction thereof.

The display controlling portion 7 switches the display contents of the displaying portion 2 from the operation screen R1 to one of the frame line added coloring pattern screens WG1, BG1, WBG1, BWG1, and DG1 described above if the operation screen R1 is switched from the normal display mode which is displayed on the displaying portion 2 to the coloring pattern selection mode.

Moreover, the controller 1 is realized by installing a computer program (software) to a computer (hardware) configured of a Central Processing Unit (CPU), a memory, an interface, and the like. Each function portion of the controller 1 is realized by cooperation of various hardware resources of the computer with the computer program. In addition, the computer program may be supplied in a state of being stored in a computer readable recording medium or memory device, or may be supplied via an electric communication line.

### <Coloring Pattern Selection Operation>

The following description is given by assuming a case in which the display controlling portion 7 of the controller 1 recognizes that a display command of the white frame line added coloring pattern screen with the color name WG1 is received by performing the touch input by the large buttons B1 and B2 via the touch panel 2a in a state in which the operation screen R1 (see FIG. 1) read from the operation screen storing portion 3 is switched from the normal display mode that is displayed on the displaying portion 2 to the coloring pattern selection mode.

In this case, the display controlling portion 7 reads the coloring pattern screen G1 from the coloring pattern screen storing portion 4 and outputs the coloring pattern screen G1 to the white frame line adding portion 5a of the frame line added coloring pattern screen generating portion 5.

The white frame line adding portion 5a generates the white frame line added coloring pattern screen WG1 (see FIG. 4) where the white frame lines WL are added to the peripheries of the plurality of display objects in the coloring pattern screen G1 and outputs the white frame line added coloring pattern screen WG1 to the color name adding portion 6.

The color name adding portion 6 adds both English notations of the white character and the black character indicating the name of the color to the inner regions of the temperature displaying portion S1, the setting temperature displaying portion S2, the small buttons b1 to b6, the large buttons B1 to B4, and the circular buttons C1 to C3 of the white frame line added coloring pattern screen WG1, and then outputs the English notations to the displaying portion 2 via the display controlling portion 7.

The displaying portion 2 displays the white frame line added coloring pattern screen with the color name WNG1 (see FIG. 9) received from the color name adding portion 6. As a result, the white frame line added coloring pattern screen with the color name WNG1, where the white frame lines WL are added to the peripheries and the color names are added to the inner regions of the temperature displaying portion S1, the setting temperature displaying portion S2, the small buttons b1 to b6, the large buttons B1 to B4, and the circular buttons C1 to C3, is displayed on the displaying portion 2.

In this case, even if the operator is the visually impaired person with color blindness who views the small buttons b1, b3, and b5 of red and the small buttons b2, b4, and b6 of green as the same color, the operator easily recognizes that the six small buttons b1 to b6 are present by the presence of the white frame lines WL and can correctly recognize coloring of each of the small buttons b1 to b6 via the English notation of the color name.

In the white frame line added coloring pattern screen with the color name WNG1, the plurality of display objects are surrounded by the white frame lines WL of a color whose contrast ratio is higher than the background image H1 of a color whose brightness value is low. Therefore, the operator can easily recognize the presence of the plurality of small buttons b1 to b6 by the presence of the white frame lines WL.

That is, the operator can intuitively understand the presence of the small buttons b1 to b6 by the presence of the white frame lines WL even if the presence and the color of the small buttons b1 to b6 cannot be correctly recognized in the coloring pattern of the white frame line added coloring pattern screen with the color name WNG1.

Moreover, in the white frame line added coloring pattern screen with the color name WNG1, the English notation indicating the color of the inner region of the display object is added by both of the white character and the black character. Therefore, in a case in which the color of the display object has a low brightness value, for example, is blue, the operator can easily and visually recognize the color name via the English notation of the white character whose brightness value is high. Similarly, in a case in which the color of the display object has a high brightness value, for example, is yellow, the operator can easily and visually recognize the color name via the English notation of the black character whose brightness value is low.

The operator recognizes the presence of the small buttons b1 to b6 by the frame lines in the white frame line added coloring pattern screen with the color name WNG1, but if the operator feels that the colors of the small buttons b1 to b6 are difficult to be recognized in the operation screen R1 in the coloring pattern, the white frame line added coloring pattern screen with the color name WNG2 that is the next coloring pattern is requested by performing touch operation of the large button B3.

The display controlling portion 7 displays the white frame line added coloring pattern screen with the color name WNG2 that is the next coloring pattern on the displaying portion 2 in accordance with the request from the operator. The operator selects and determines the white frame line added coloring pattern screen with the color name WNG2 via the touch panel 2a if the colors of the small buttons b1 to b6 can be recognized in the white frame line added coloring pattern screen with the color name WNG2 in a distinguishable state of the colors.

The display controlling portion 2 generates the operation screen R1, where coloring of the background image H1, the small buttons b1 to b6, and the like is changed in accordance with the coloring pattern of the white frame line added coloring pattern screen with the color name WNG2 determined via the touch panel 2a, and displays the operation screen R1 on the displaying portion 2.

Therefore, the operator visually recognizes the operation screen R1 of the same coloring pattern as the white frame line added coloring pattern screen with the color name WNG2 selected by the operator. Thus, the operator can recognize the small buttons b1 to b6 to which the frame lines are not added in the operation screen R1 by correctly distinguishing the small buttons b1 to b6.

However, in a case in which the operator of the visually impaired person with color blindness feels that the plurality of display objects are difficult to be recognized by distinguishing each of the display objects in the white frame lines WL in the white frame line added coloring pattern screen with the color name WNG1, the touch input of the large button B1 may be performed to switch the types of the frame lines.

Therefore, the display controlling portion 7 generates the black frame line added coloring pattern screen BG1 to which the color name is added, the two-type frame line added coloring pattern screens BWG1 and WBG1 to which the color name is added, or the white and black dotted frame line added coloring pattern screen with the color name DNG1 as illustrated in FIG. 10, and can display the screens on the displaying portion 2.

In the black frame line added coloring pattern screen BG1 to which the color name is added, the black frame line BL is added to the periphery of the display object. Therefore, the operator clearly views the black frame lines BL, whose brightness value is low with respect to the small buttons b1 to b6 whose brightness value is high, and the operator can instantly and intuitively recognize the presence of the small buttons b1 to b6.

In addition, in the two-type frame line added coloring pattern screens BWG1 and WBG1 to which the color name is added, the operator inevitably and clearly views at least one of the white frame line WL and the black frame line BL in accordance with coloring of the background image H1 and the plurality of display objects, and the operator necessarily and clearly views at least one of the English notations of the white character and the black character. Therefore, the operator can correctly recognize the presence and the color of the plurality of display objects.

Furthermore, in the white and black dotted frame line added coloring pattern screen with the color name DNG1 to which the color name is added, in a case in which coloring of the background image H1 and the plurality of display objects is a dark color whose brightness value is low, since white configuring the white and black dotted line is mainly recognized, the operator clearly views the white and black dotted line as a white dotted line.

In addition, in a case in which coloring of the background image H1 and the plurality of display objects is a bright color whose brightness value is high, since black configuring the white and black dotted line is mainly recognized, the operator clearly views the white and black dotted line as a black dotted line. Therefore, in the white and black dotted frame line added coloring pattern screen with the color name DNG1, the operator can instantly recognize the presence of the plurality of display objects.

Furthermore, in the white and black dotted frame line added coloring pattern screen with the color name DNG1, the operator clearly views at least one of the English notations of the white character and the black character. Therefore, the operator can also correctly recognize the colors of the plurality of display objects.

Therefore, even if the operator is the visually impaired person with color blindness, the plurality of display objects are present in the background image H1 by the white frame line WL, the black frame line BL, the two-type frame line (the white frame line WL and the black frame line BL), or the white and black dotted frame line DL, and the color of each of the plurality of display objects can be correctly recognized. Then, the operator correctly recognizes the colors of the plurality of display objects and then can finally select and determine the coloring pattern whose color with respect to the display object can be distinguished while switching the coloring pattern in order by pressing the large button B3 or B4.

Thus, the operator can easily select and determine the coloring pattern which can be correctly recognized in the operation screen R1 via the white frame line added coloring pattern screen with the color name WNG1, the black frame line added coloring pattern screen BG1 to which the color name is added, the two-type frame line added coloring pattern screens BWG1 and WBG1 to which the color name is added, or the white and black dotted frame line added coloring pattern screen with the color name DNG1.

### <Advantages>

In such a controller 1, the white frame line added coloring pattern screen with the color name WNG1 of the same shape, the same size, the same number, and the same layout as those of the plurality of display objects of the operation screen R1 displayed in the practical normal display mode is displayed on the displaying portion 2.

In this case, there is a less impressive difference between the display object of the operation screen R1 and the display object of the white frame line added coloring pattern screen with the color name WNG1. Therefore, the operator who views the white frame line added coloring pattern screen with the color name WNG1 has no incompatible sense with the operation screen R1 when selecting the coloring pattern.

In addition, the controller 1 displays the white frame line added coloring pattern screen with the color name WNG1 on the displaying portion 2 only in the coloring pattern selection mode in which the operator selects the coloring pattern of the operation screen R1 and displays the operation screen R1 on the displaying portion 2 in the normal display mode. Therefore, it is possible to maintain superiority of the flat design of the operation screen R1 in the normal display mode.

Furthermore, the controller 1 is configured such that the operator can correctly recognize the presence and the colors of the plurality of display objects by the white frame line WL of the white frame line added coloring pattern screen with the color name WNG1 in the coloring pattern selection mode. Therefore, it is possible to assist the operator of the visually impaired person with color blindness when selecting the optimal coloring pattern.

### Other Embodiments

Moreover, in the embodiment described above, a case, in which the color name is added to the display object with the English notations of both of the white character and the black character by the color name adding portion 6, is described. However, the invention is not limited to the embodiment and the color name of one of the white character and the black character may be added only in a case in which a constant contrast ratio with respect to the color of the display object is obtained.

In addition, in the embodiment described above, a case in which the color name is added to the display object with the English notations of both of the white character and the black character by the color name adding portion 6 is described. However, the invention is not limited to the embodiment and the English notation of the white character and the English notation of the black character added to the display object by the display controlling portion 7 may be alternately displayed at predetermined time intervals.

In this case, for example, the white frame line added coloring pattern screen with the color name WNG1 to which only the English notation of the white character is added and the white frame line added coloring pattern screen with the color name WNG1 to which only the English notation of the black character is added are generated, and may be alternately displayed on the displaying portion 2 at predetermined time intervals by the display controlling portion 7.

In addition, in the embodiment described above, a case, in which the white frame line WL or the black frame line BL that is set in advance is added to the plurality of display objects as the two-type frame line added coloring pattern screens WBG1 and BWG1, is described, but the invention is not limited to the embodiment. The frame line added coloring pattern screen generating portion 5 may add the white frame line WL or the black frame line BL whose contrast ratio is increased in accordance with the brightness value of the color by necessarily combining the white frame line WL and the black frame line BL such that in a case of the dark color in which the brightness value of the color of the display object is equal to or less than a threshold, the white frame line WL is added and in a case of the bright color in which the brightness value of the color of the display object exceeds the threshold, the black frame line BL is added.

In addition, in the embodiment described above, a case, in which the display objects in the coloring pattern screens G1 to Gn are provided in the same shape, the same size, the same number, and the same position (layout) on the background image H1 as the display object of the operation screen R1, is described. However, the invention is not limited to the embodiment. The shape, the size, the number, and the like may be changed in a range in which the layout of the plurality of display objects in the coloring pattern screens G1 to Gn is the same layout as the plurality of display objects in the operation screen R1 and the operator does not receive incompatible sense between the coloring pattern screens G1 to Gn and the operation screen R1.

In addition, in the embodiment described above, a case of being applied to the controller 1 is described. However, the invention is not limited to the embodiment and it may be applied to various other electronic devices in which the plurality of display objects are displayed as selection objects.

### DESCRIPTION OF REFERENCE NUMERALS AND SIGNS

1 . . . controller, 2 . . . displaying portion, 2a . . . touch panel, 3 . . . operation screen storing portion, 4 . . . coloring pattern screen storing portion (storing portion), 5 . . . frame line added coloring pattern screen generating portion (generating portion), 5a . . . white frame line adding portion, 5b . . . black frame line adding portion, 5c . . . two-type frame line adding portion, 5d . . . white and black dotted frame line adding portion, 6 . . . color name adding portion (generating portion), 7 . . . display controlling portion.

1. A coloring pattern screen display device comprising:
a storing portion configured to store a plurality of coloring pattern screens in which a plurality of display objects, where frame lines are not provided in peripheries thereof, are disposed in a background image, and which have coloring patterns where arbitrary colors are set to the background image and the plurality of display objects;
a generating portion configured to generate a plurality of frame line added coloring pattern screens where the frame lines are added to the peripheries of the plurality of display objects in the coloring pattern screens; and
a display controlling portion configured to display the plurality of frame line added coloring pattern screens generated by the generating portion on a displaying portion in a case in which a mode is switched from a normal display mode in which an operation screen, where a plurality of display objects are disposed, is displayed in the predetermined displaying portion to perform a normal screen operation to a coloring pattern selection mode in which a user selects desired coloring pattern screens.

2. The coloring pattern screen display device according to claim 1, further comprising:
a receiving portion configured to receive a selection result when the user selects the desired frame line added coloring pattern screen from among the plurality of frame line added coloring pattern screens,
wherein the display controlling portion is configured to generate the operation screen where the background image and the plurality of display objects are set in the same coloring pattern as the frame line added coloring pattern screen corresponding to the selection result of the receiving portion and displays the operation screen on the displaying portion.

3. The coloring pattern screen display device according to claim 1,
wherein a layout of the plurality of display objects disposed in the frame line added coloring pattern screen is the same as the plurality of display objects disposed in the operation screen.

4. The coloring pattern screen display device according to claim 3,
wherein the generating portion is configured to add the frame lines of monochrome.

5. The coloring pattern screen display device according to claim 4,
wherein the generating portion is configured to add a white frame line or a black frame line as the frame line.

6. The coloring pattern screen display device according to claim 4,
wherein the generating portion is configured to add a white frame line or a black frame line as the frame line for each of the display objects.

7. The coloring pattern screen display device according to claim 4,
wherein the generating portion is configured to add a dotted frame line in which white and black are alternately arranged as the frame line.

8. The coloring pattern screen display device according to claim 4,
wherein the generating portion further comprises a color name adding portion that is configured to add both a white character and a black character, which indicate names of colors that are set to the display objects to each of the plurality of display objects.

9. The coloring pattern screen display device according to claim 5,
wherein the generating portion further comprises a color name adding portion that is configured to add both a white character and a black character, which indicate names of colors that are set to the display objects to each of the plurality of display objects.

10. The coloring pattern screen display device according to claim 6,
wherein the generating portion further comprises a color name adding portion that is configured to add both a white character and a black character, which indicate names of colors that are set to the display objects to each of the plurality of display objects.

11. The coloring pattern screen display device according to claim 8,
wherein the display controlling portion is configured to alternately display the white character and the black character added to each of the plurality of display objects for each predetermined time.

12. The coloring pattern screen display device according to claim 9,
wherein the display controlling portion is configured to alternately display the white character and the black character added to each of the plurality of display objects for each predetermined time.

13. The coloring pattern screen display device according to claim 10,
wherein the display controlling portion is configured to alternately display the white character and the black character added to each of the plurality of display objects for each predetermined time.
